(19) United States
(12) Patent Application Publication
(10) Pub. No.: US 2010/0240019 A1
(43) Pub. Date: Sep. 23, 2010

(54) INSTRUCTIONAL AIDS AND METHODS

(76) Inventor: Kumar R. Sathy, Durham, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 12/405,852

(22) Filed: Mar. 17, 2009

(51) Int. Cl. G09B 19/00

(52) U.S. Cl. 434/365; 434/167

(57) ABSTRACT

An instructional aid includes viewable alphanumeric text embodying content to be conveyed to a student, and identifiers dispersed within the instructional aid adjacent to at least selected items of said viewable alphanumeric text, with different identifiers corresponding to specific educational standards of at least one region. The content of the instructional aid may consist primarily of fiction, and/or encompass multiple academic disciplines, including at least two of (i) science, (ii) mathematics, (iii) social studies, and (iv) English, language arts, reading, and/or writing. A viewable index correlating the identifiers to educational standards of the at least one region may be provided.

### FIELD OF THE INVENTION

The present invention relates to instructional aids to promote student learning and to facilitate compliance with region-specific educational standards.

### DESCRIPTION OF THE RELATED ART

Recent years have witnessed a movement to develop regional (e.g., local and national) educational standards to define knowledge and skills that students should possess at specified points (e.g., grades or ages) in their educational careers. Standardized tests intended to check whether students have demonstrated proficiency with regional educational standards are administered on a periodic (e.g., annual) basis. Grade-specific annual instructional programs are based on the assumption that students have gained proficiency with the educational standards for the prior grade and/or year.

Stakes associated with standardized tests are high, as school funding, school ratings, and even continued independent school operation may be contingent on student test scores.

Despite the importance of regional educational standards, there exists a lack of instructional materials that fully address and incorporate such region-specific standards in a meaningful way. Textbooks are typically discipline-specific and are typically intended for use in numerous regions to maximize potential sales volume. Generic materials intended for audiences spanning regions with different educational standards may be difficult to adapt for use in a specific region to sufficiently focus on that region's educational standards. Teachers and school administrators often spend substantial resources trying to find or adapt materials to enable focused instruction of regional standards. Without identification of correlation between content contained in an instructional aid and a specific educational standard, substantial effort is required to review and evaluate instructional aids to establish whether one or more portions of an instructional aid may be helpful in teaching concepts embodied in specific educational standards. Accordingly, review and evaluation efforts typically need to be replicated for each different discipline (e.g., social studies, math, language arts, etc.), given that traditional instructional materials are usually specific to individual academic disciplines. Subject matter indices at the back of traditional textbooks may be of limited value in facilitating correlation between instructional aid content and educational standards, due to variations in specificity and terms used in textbook indices as compared to concepts embodied in region-specific educational standards.

The lack of correlation between instructional aids and region-specific educational standards has caused several negative effects. Teachers and school administrators spend an inordinate amount of time trying to adapt numerous generic materials to region-specific requirements. This reduces resources that may otherwise be available to enhance student instruction. The use of selected portions of multiple different instructional aids also unduly increases the expense for same incurred by school districts and/or parents. Absent explicit correlation between instructional aids and region-specific educational standards, parents have limited ability to determine whether instructional aids utilized by their children fully embody region-specific educational standards.

Conventional instructional aids that have been adapted and used for teaching subsets of material embodied in region-specific educational standards are typically focused on a single academic discipline and typically embody non-fiction resources. Multiple instructional aids are typically required to satisfy the full complement of educational standards applicable to a particular region. The lack of integration between multiple instructional aids results in a suboptimal educational experience, as students are forced to switch frequently between different instructional aids and may have difficulty maintaining engagement with each required contextual reorientation.

It would be desirable to provide instructional aids that help teach knowledge and skills embodied in a full range of regional educational standards, and to minimize the efforts of teachers and school administrators in evaluating generic instructional aids and adapting same to regional educational standards applicable to a specific school. It would further be desirable to provide instructional aids spanning multiple academic disciplines. It would also be desirable to provide instructional aids capable of retaining student interest and therefore promote retention of information and skill development promoted by the instructional aids.

### SUMMARY OF THE INVENTION

The present invention relates in one aspect to an instructional aid correlated to educational standards of at least one region, the instructional aid comprising: viewable alphanumeric text embodying content to be conveyed to a student; and a plurality of identifiers dispersed within the instructional aid adjacent to at least selected items of said viewable alphanumeric text, wherein different identifiers of said plurality of identifiers correspond to specific educational standards of the at least one region; wherein the instructional aid is characterized by at least one of the following features (a) and (b): (a) the content encompasses a plurality of academic disciplines, including at least two of the following academic disciplines (i) to (iv): (i) science; (ii) mathematics; (iii) social studies; and (iv) any of English, language arts, reading, and writing; and (b) the content consists primarily of fiction. Such instructional aid may desirably include a viewable index correlating said plurality of identifiers to educational standards of the at least one region

In another aspect, the present invention relates to an educational instruction method including providing access to an instructional aid as disclosed herein.

In another aspect, the present invention relates to an educational instruction method including use of an instructional aid as disclosed herein.

Other aspects, features and embodiments of the invention will be more fully apparent from the ensuing disclosure and appended claims.

### BRIEF DESCRIPTION OF THE DRAWINGS

FIG. 1A is a schematic view of computer hardware and software system including an instructional device, adapted to implement methods as disclosed herein, and according to at least one embodiment of the present invention.

FIG. 1B is a schematic view of a communication system embodying multiple instructional devices and adapted to implement methods as disclosed herein, according to at least one embodiment of the present invention.

FIG. 2 is a schematic view of an instructional device display window including content and associated identifiers arranged as hyperlinks dispersed within content contained in the display window, with different identifiers corresponding to specific educational standards of at least one region, according to at least one embodiment of the present invention.

FIGS. 3A-3J embody an index correlating identifiers (“reference numbers”) to specific educational standards of at least one region, including identification of four subjects (academic disciplines), with region-specific official identification numbers, and descriptions of concepts embodied in each specific educational standard, according to at least one embodiment of the present invention.

FIG. 4A is an excerpt from an instructional aid, including one viewable page or frame thereof, according to an embodiment of the present invention.

FIG. 4B is another excerpt from an instructional aid, including one viewable page or frame thereof, according to an embodiment of the present invention.

FIG. 4C is another excerpt from an instructional aid, including one viewable page or frame thereof, according to an embodiment of the present invention.

FIG. 4D is another excerpt from an instructional aid, including one viewable page or frame thereof, according to an embodiment of the present invention.

FIG. 4E is another excerpt from an instructional aid, including one viewable page or frame thereof, according to an embodiment of the present invention.

FIG. 4F is another excerpt from an instructional aid, including one viewable page or frame thereof, according to an embodiment of the present invention.

FIG. 4G is another excerpt from an instructional aid, including one viewable page or frame thereof, according to an embodiment of the present invention.

FIG. 4H is another excerpt from an instructional aid, including one viewable page or frame thereof, according to an embodiment of the present invention.

FIG. 4I is another excerpt from an instructional aid, including one viewable page or frame thereof, according to at least one embodiment of the present invention.

FIG. 4J is another excerpt from an instructional aid, including one viewable page or frame thereof, according to at least one embodiment of the present invention.

### DETAILED DESCRIPTION OF THE INVENTION, AND PREFERRED EMBODIMENTS THEREOF

The present invention relates to an instructional aid that is correlated to educational standards of at least one region. Content of the instructional aid includes viewable alphanumeric text. A plurality of identifiers are dispersed within the instructional aid adjacent to at least selected items of the viewable alphanumeric text, with different identifiers corresponding to specific educational standards of the at least one region. In one embodiment, the instructional aid consists primarily of fiction. In another embodiment, the content of the instructional aid encompasses a plurality of academic disciplines, including at least two of the following disciplines (i) to (iv): (i) science; (ii) mathematics; (iii) social studies; and (iv) any of English, language arts, reading, and writing. In another embodiment, characteristics of both of the foregoing embodiments are combined.

The term “instructional aid” as used herein refers to a literary work, device, medium, computer-readable instruction set, or operable system, arranged to facilitate student instruction and/or student learning.

The phrase “consists primarily of fiction,” as used herein refers to content that is preferably at least about 60% fictional; more preferably at least about 70% fictional; more preferably at least about 80% fictional; more preferably at least about 90% fictional; and still more preferably at least about 95% fictional. In one embodiment, fictional content is measured on a sentence-specific basis, such as when 70% of the sentences of an instructional aid consist of fictional content, or, alternatively, are devoid of non-fictional content). In other embodiments, fictional content is measured on a paragraph-specific basis, or on a page-specific basis. Fictional content may include, for example, fictional elements such as fictional characters, fictional places, and/or fictional events or situations. In one embodiment, a selected sentence, paragraph, or page may be considered fictional within the meaning of the above thresholds if the sentence, paragraph, or page includes reference to any fictional character, fictional place, or fictional event or situation. In another embodiment, In one embodiment, a selected sentence, paragraph, or page may be considered fictional within the meaning of the above thresholds if the sentence, paragraph, or page is devoid of any reference to an actual person, actual place, or actual event or situation.

The phrase “encompasses a plurality of academic disciplines,” as used herein refers to the presence of content having teachable concepts directed to more than one academic discipline (or “subject”) as referenced in a region-specific educational standard. The term “encompasses” contemplates more than token reference or passing reference to a second or subsequent academic discipline. In various embodiments, content included in the instructional aid encompasses at least two, preferably at least three, and still more preferably at least four of the following academic disciplines (i) to (iv): (i) science; (ii) mathematics; (iii) social studies; and (iv) any of English, language arts, reading, and writing. In one embodiment, an instructional aid is divided into multiple chapters, with at least some chapters including content including at least two, more preferably at least three, and more preferably at least four of the foregoing academic disciplines. In one embodiment, an instructional aid embodies a plurality of pages or windows, with at least some pages or windows including content including at least two, more preferably at least three, and more preferably at least four of the foregoing academic disciplines.

In a preferred embodiment, an instructional aid includes a viewable index correlating the plurality of identifiers to educational standards of the at least one region. The term “viewable index” as used herein refers to an index that may be presented in whole or in part to a user or viewer in any suitable permanent or non-permanent format, including, for example, in print form on a printed document or volume, or in display form on a suitable display device such as a monitor or display screen. At least a portion of such index may be viewable at any one time.

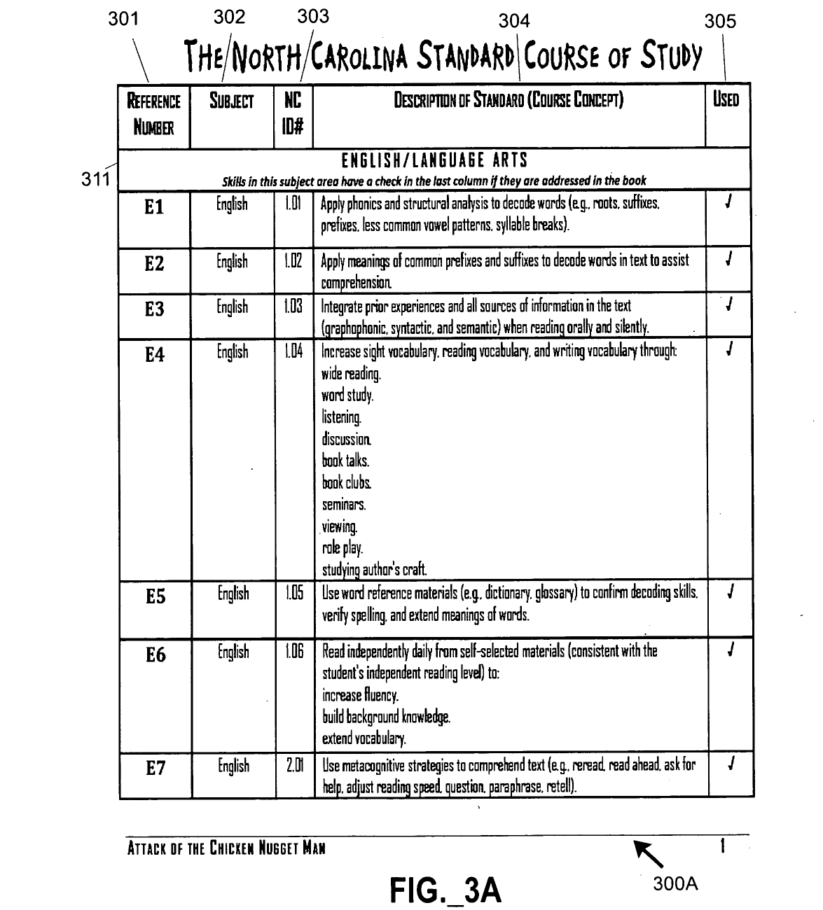

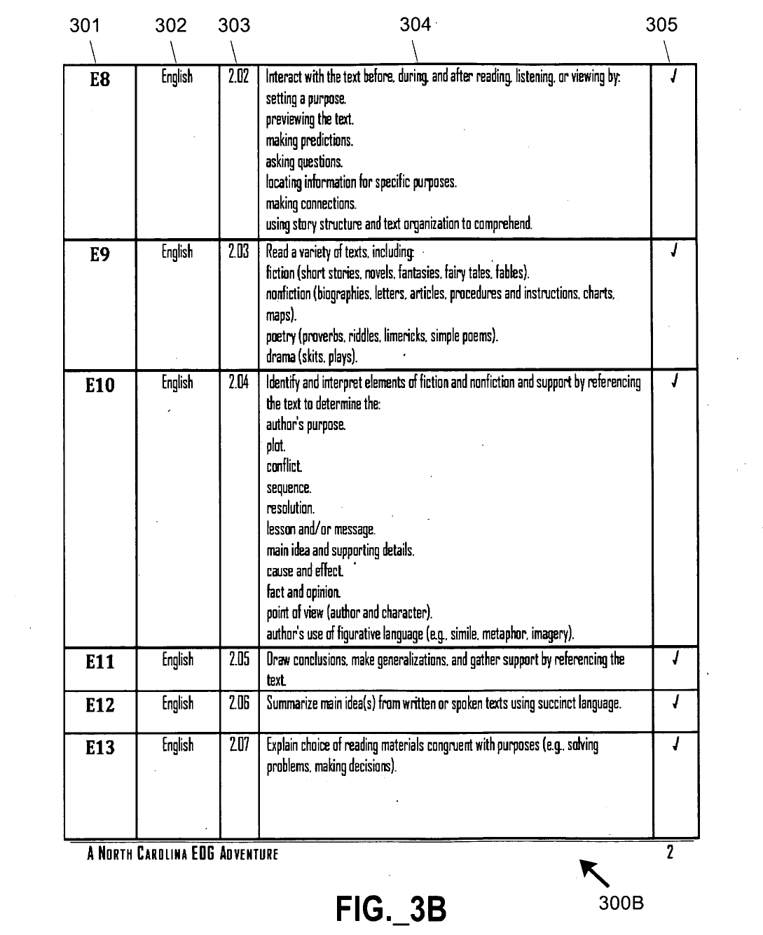

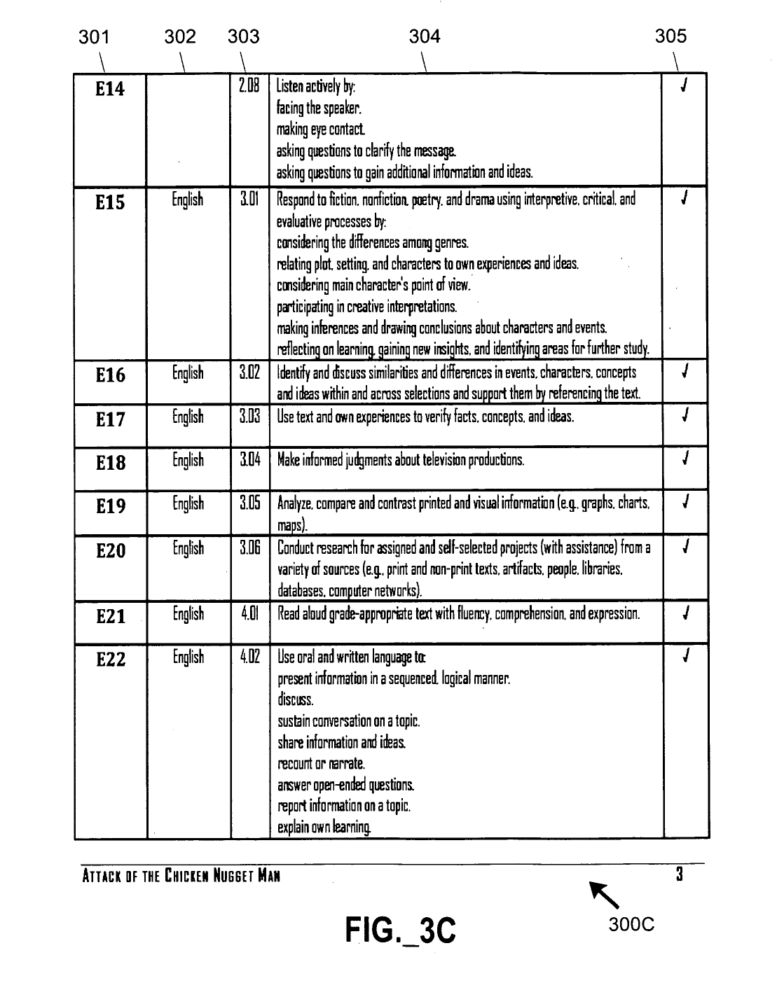

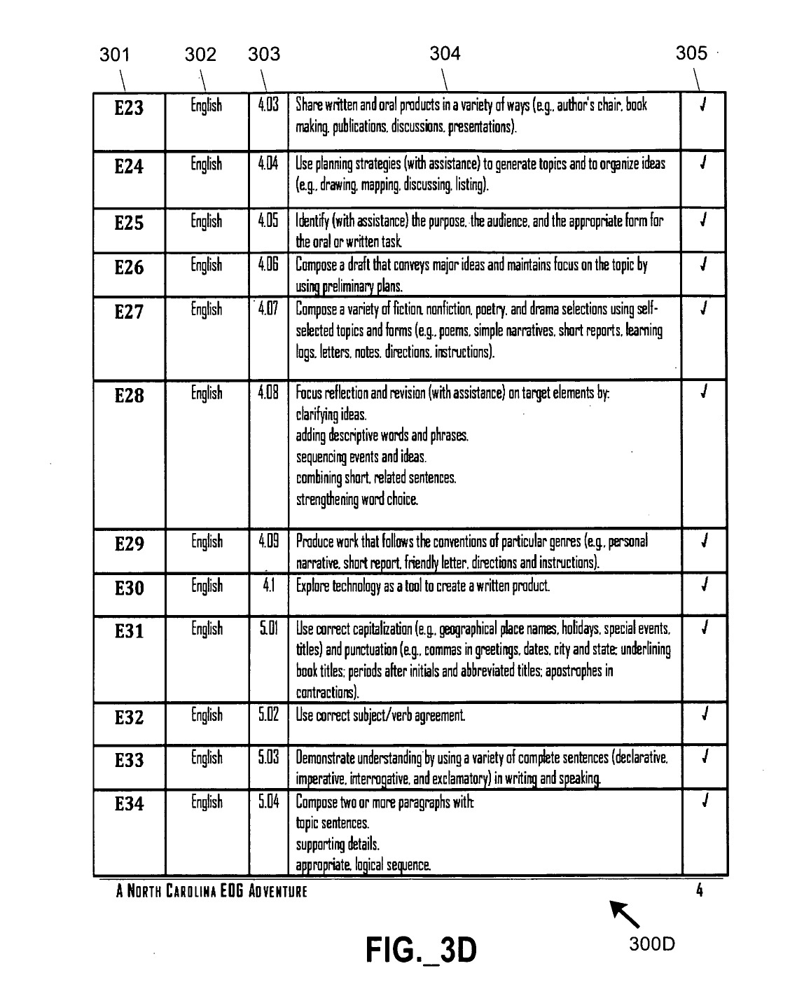

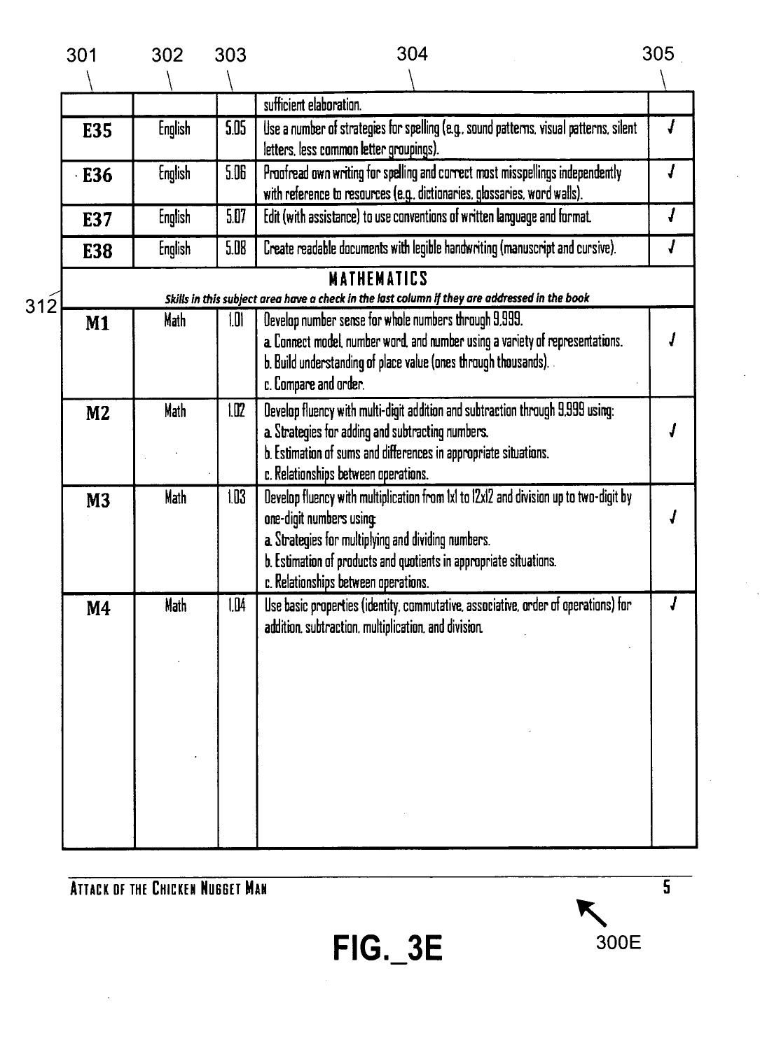

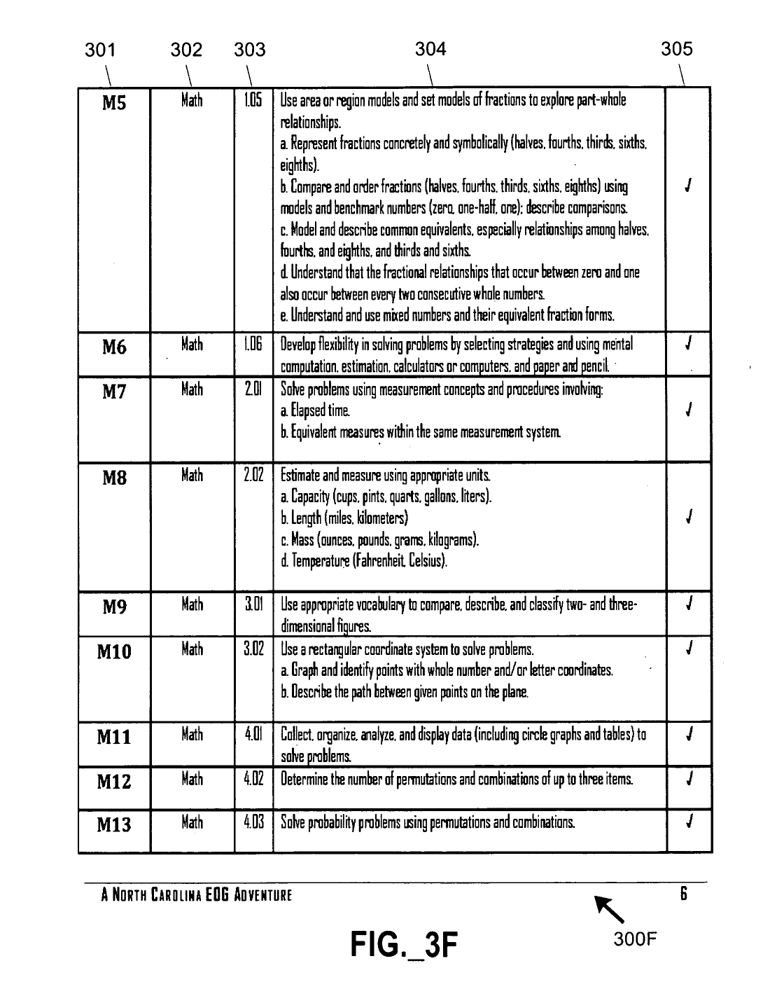

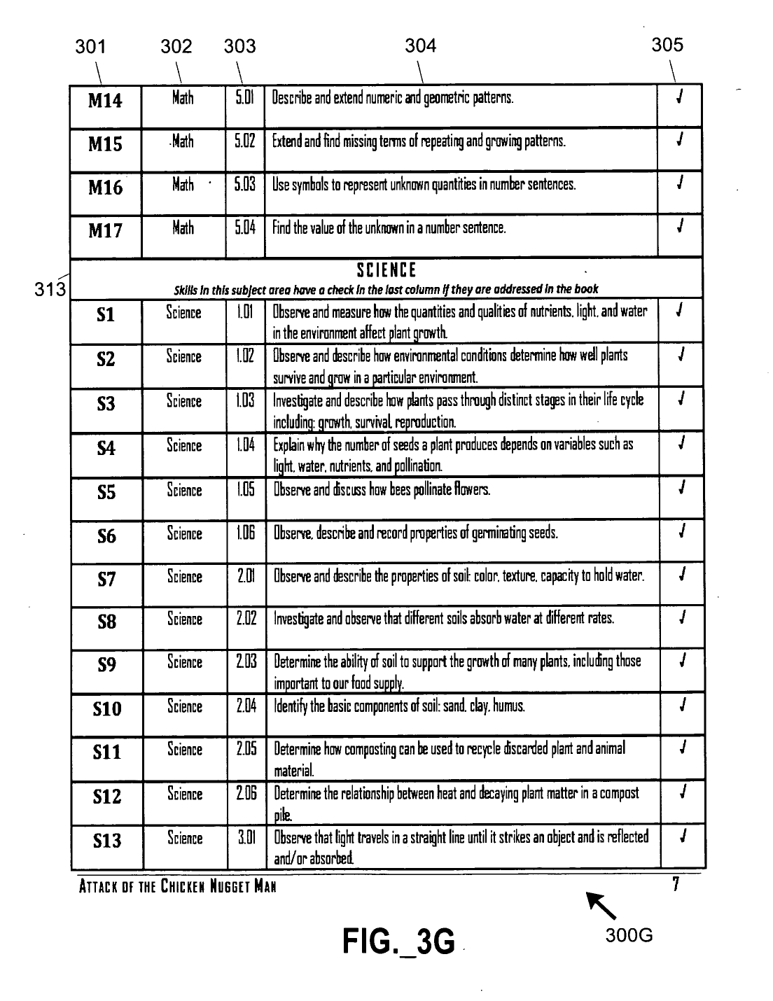

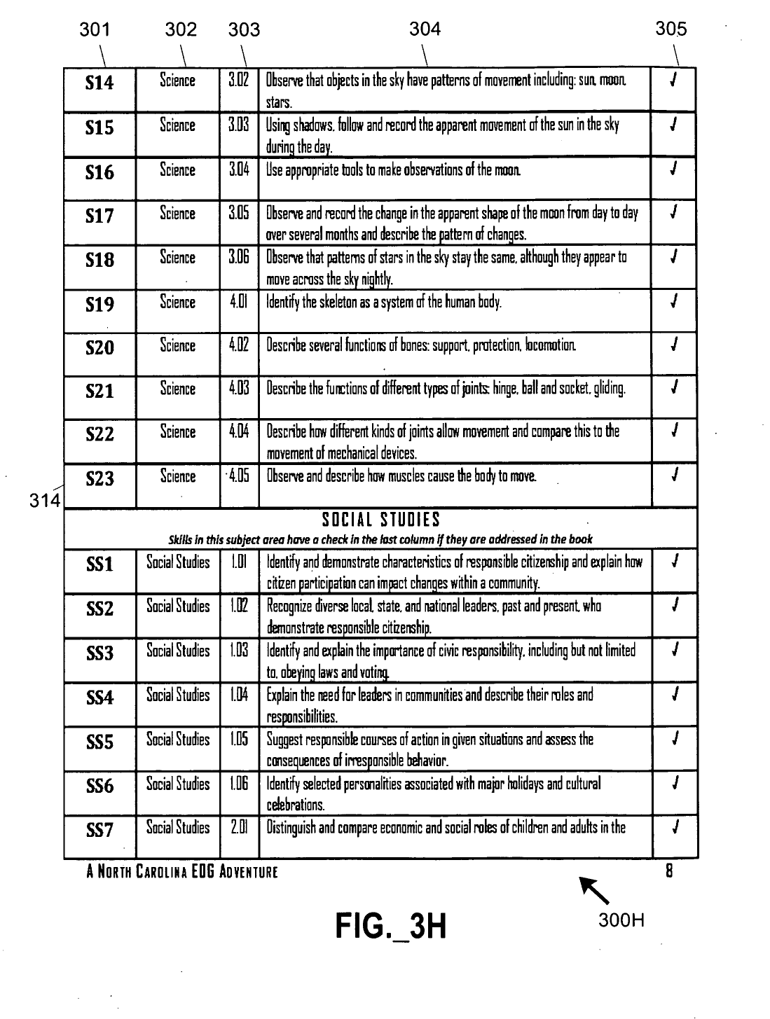

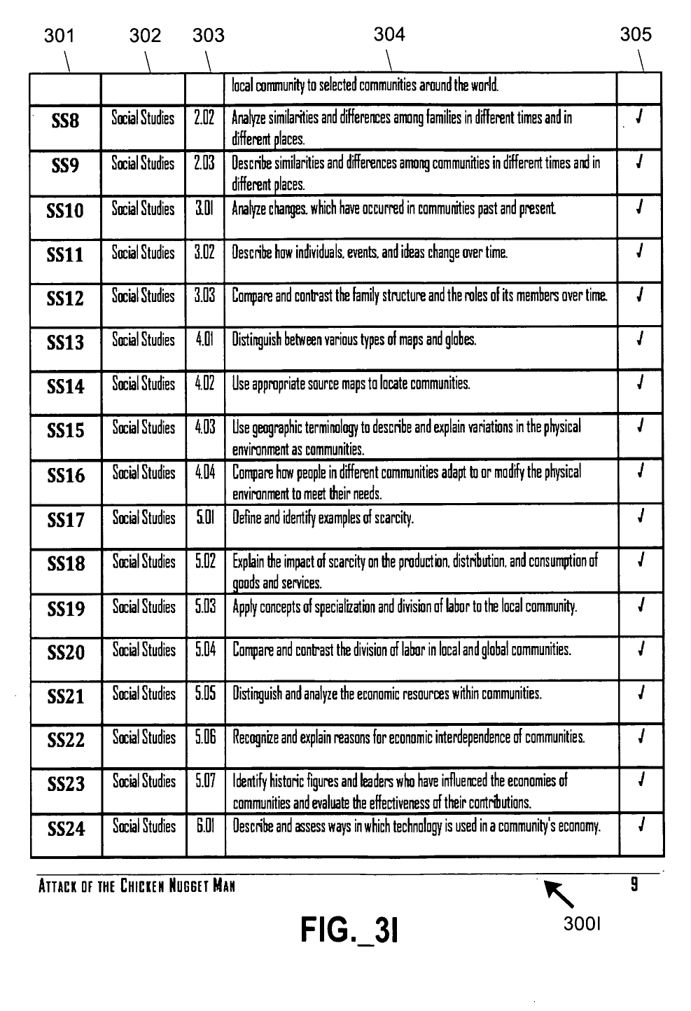

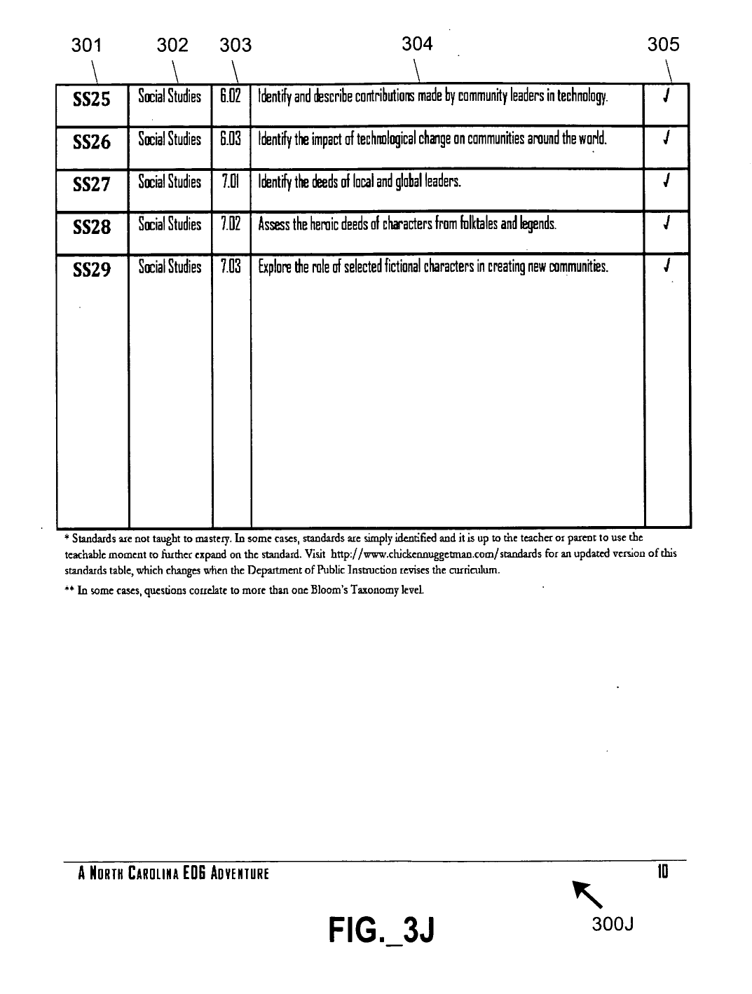

Identifiers corresponding to specific educational standards may be of any suitable user-perceptible type. In various embodiments, identifiers may include different alphanumeric symbols, symbolic elements, shapes, and/or colors in various combinations. One example of an index 300 (consisting of portions 300A-300J in combination) according to one embodiment is illustrated in FIGS. 3A-3J. The index 300 includes five fields 301-305 (namely, identifier reference number 301, subject 302, regional educational standard identification 303, description of standard or course concept 304, and included use 305) and spans four academic subjects or disciplines (namely, (i) English/Language Arts, (ii) Mathematics, (iii) Science, and (iv) Social Studies). The identifiers provided in the first column 301 of the index 300 embody one or more letters (i.e., “E,” “M,” “S,” or “SS”) combined with one or more numbers. The academic discipline or subject embodied in the second column 302 is represented in word form (i.e., English, Math, Science, or Social Studies). The regional educational standards in the third column 303 of the index 300 are represented in numerical codes. The description of standard or course concept 304 preferably includes a description of the entire standard, or at least a descriptive abbreviation thereof, to permit the user to understand the nature and purpose of each educational standard. The fifth column 305 as illustrated in FIGS. 3A-3J includes check marks to demonstrate inclusion of content relating to each regional educational standard in the instructional aid. In an alternative embodiment, the fifth column 305 may include page, chapter, and or section numbers corresponding to inclusion of content corresponding to each educational standard in the instructional aid.

While the educational standards exemplified in FIGS. 3A-3J correspond to those of the State of North Carolina, it is to be understood that educational standards for any one or more specific regions may be embodied in a similar index. In one embodiment, an index may include identifiers correlated to educational standards for multiple (e.g., two, three, or more) regions. In one embodiment, an instructional aid may include content and a related index embodying educational standards applicable to distinct geographic regions that are not overlapping (e.g., educational standards for different states). In another embodiment, an instructional aid may include content and a related index embodying educational standards applicable to overlapping geographic regions (e.g., state-specific and district-specific educational standards, with the district lying within the selected state).

In one embodiment, an instructional aid according to the present invention may comprise a non-electronic print medium. Examples of non-electronic print media include, but are not limited to, literary works, books, printed volumes, pamphlets, and printed transparencies adapted to permit projected display. Identifiers may be dispersed within the instructional aid, with identifiers correlated to academic standards of one or more regions preferably being linked to specific sentences (i.e., on a sentence-specific basis). In other embodiments, identifiers may be linked on a paragraph-specific basis and/or page-specific basis. In one embodiment, multiple identifiers may be associated with a specific sentence, and/or with a specific paragraph. In one embodiment, multiple identifiers correlated to different academic discipline may be associated with a specific sentence, and/or with a specific paragraph. A single instructional aid may therefore include content embodying and correlated to multiple educational standards of one or more regions. In a preferred embodiment, an instructional aid includes content embodying and correlated to all or substantially all of the educational standards of one or more regions.

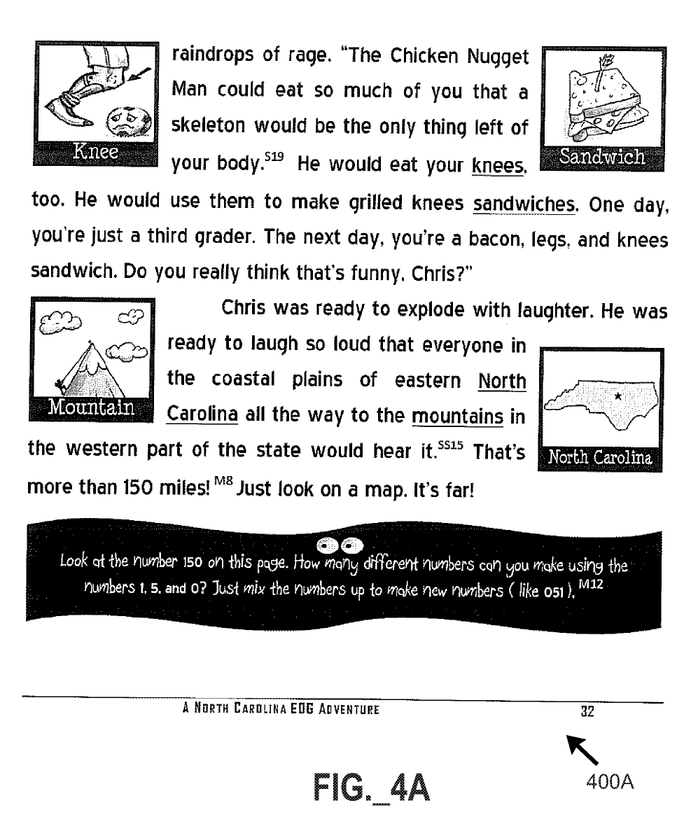

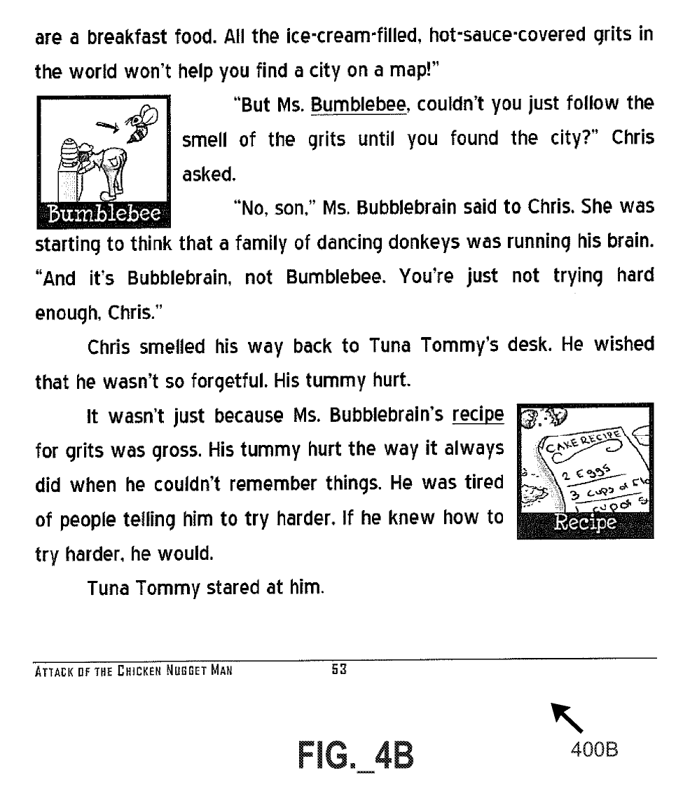

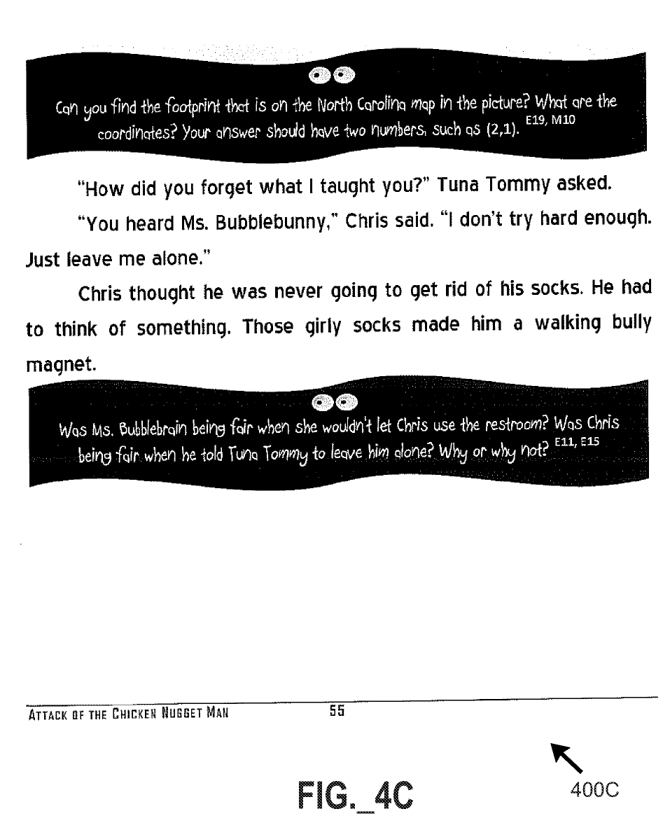

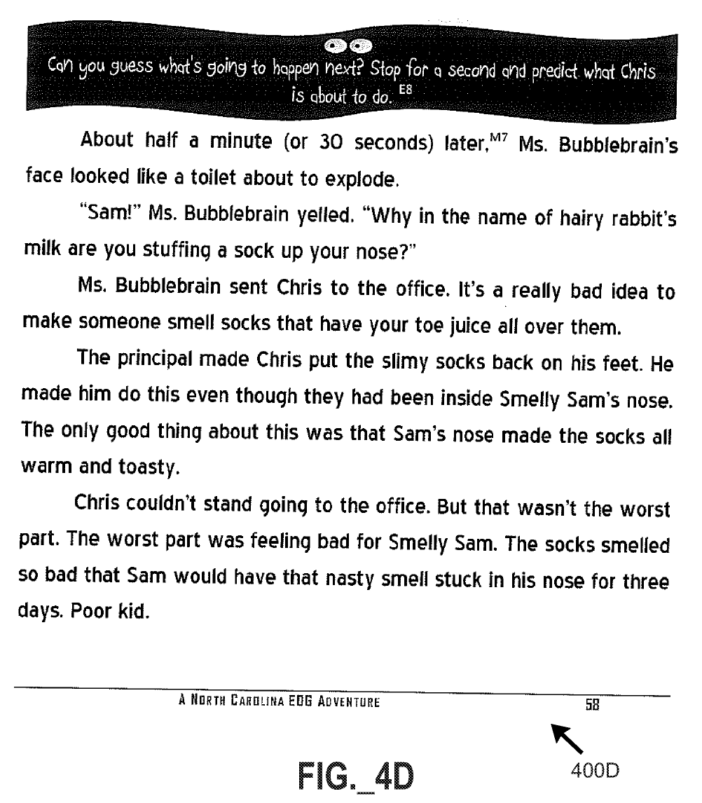

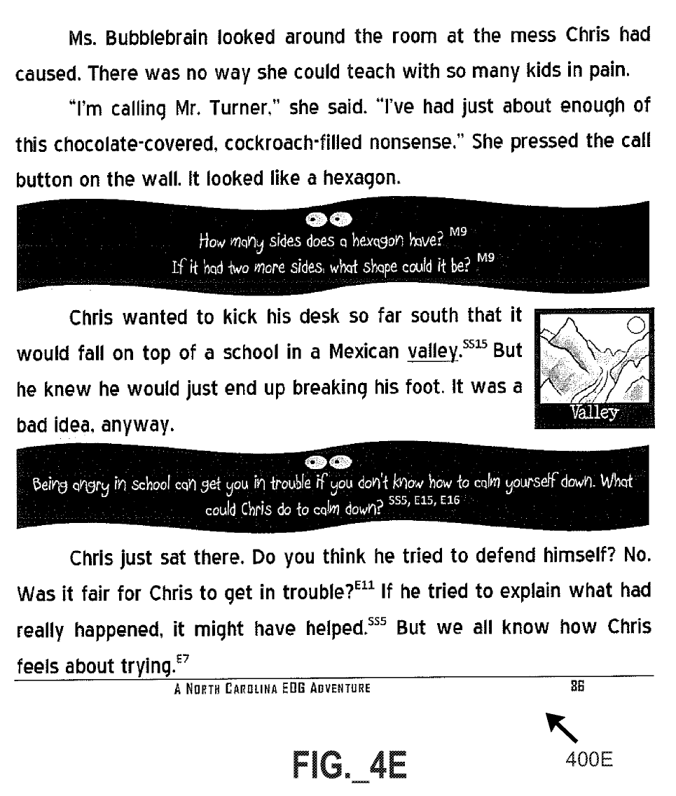

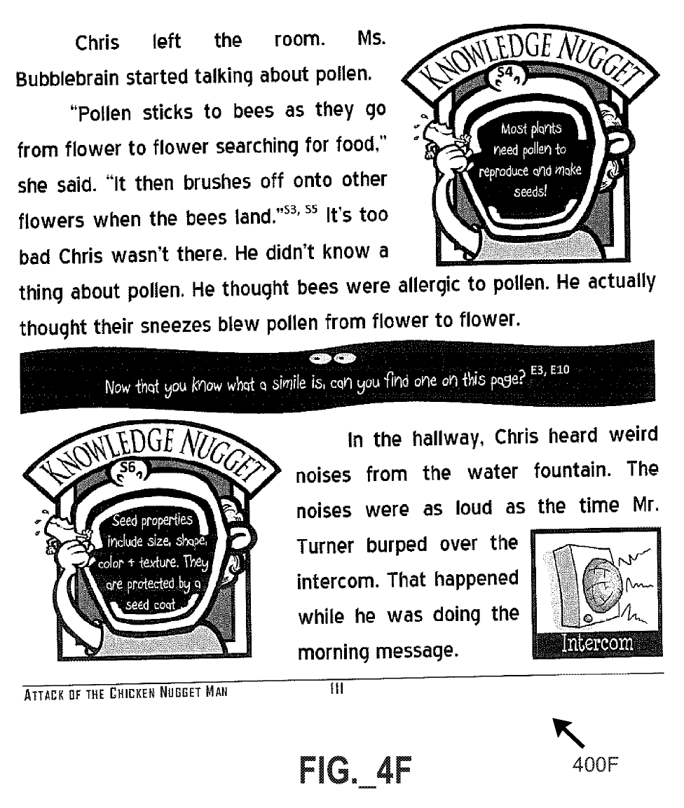

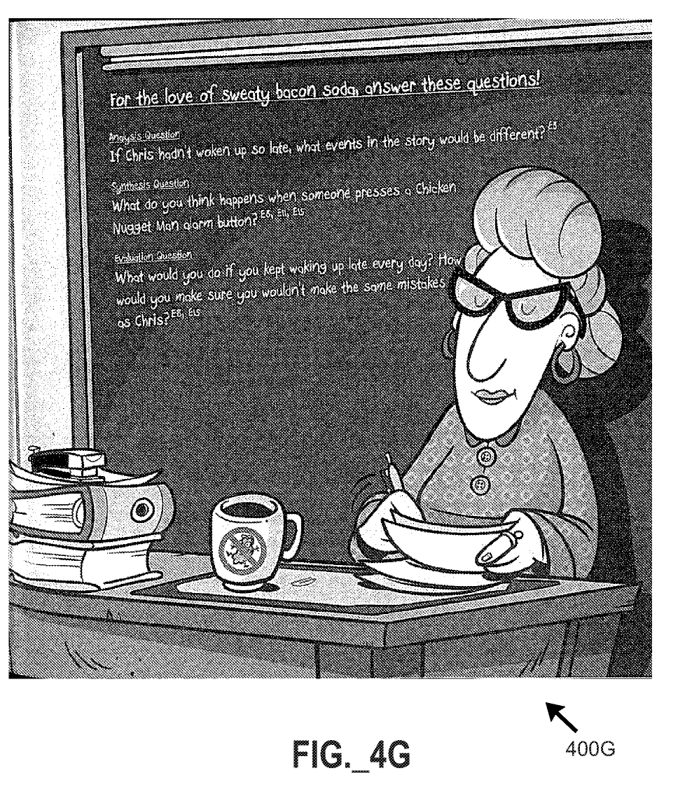

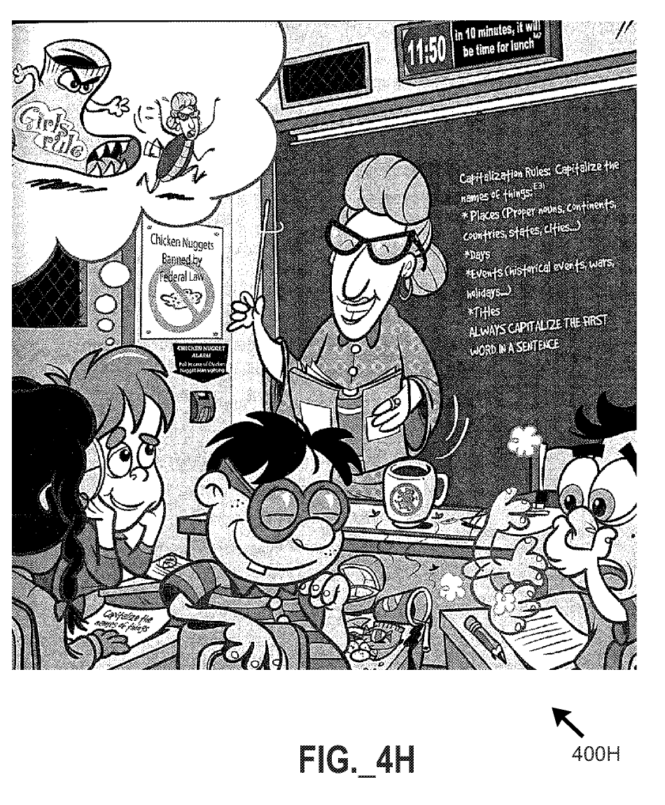

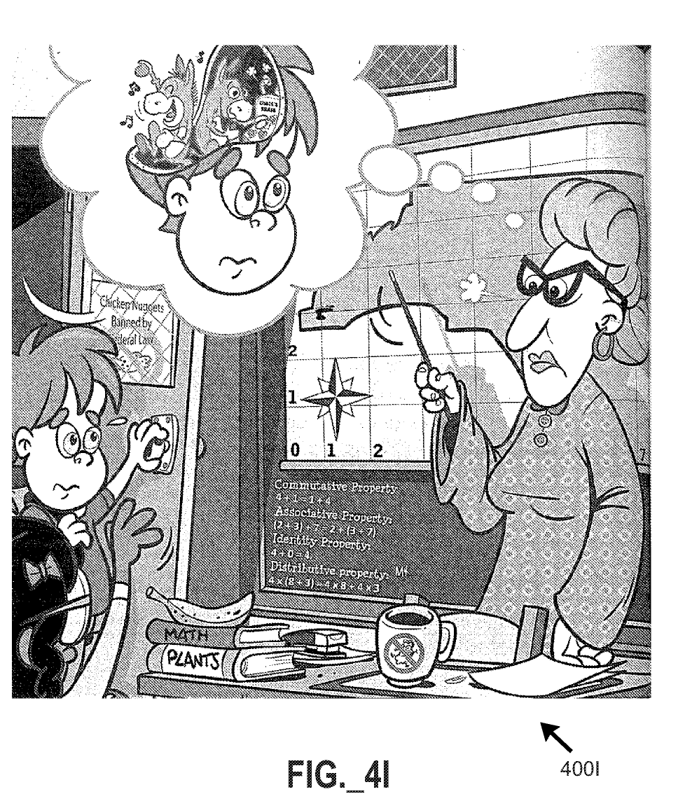

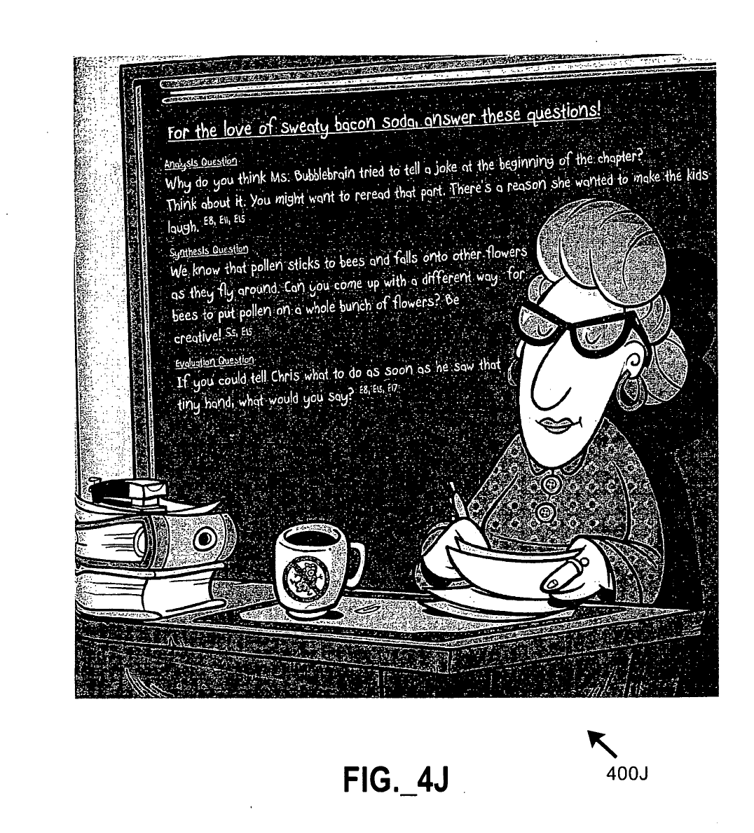

FIGS. 4A-4J represent excerpts from an instructional aid, including viewable pages or frames thereof, according to one embodiment of the present invention. The instructional aid exemplified in FIGS. 4A-4J is a textbook entitled “Attack of the Chicken Nugget Man” adapted for use by third-grade students in North Carolina. The textbook consists primarily of fiction, and is integrated with a fictional storyline. The phrase “integrated with a fictional storyline” as used herein refers to content that is arranged with one or more fictional thematic elements (e.g., fictional characters, fictional places, and/or fictional events or situations) flowing from one portion (e.g., section, chapter, or module) to another. The textbook further includes content encompassing a plurality of academic disciplines—including all four of the following academic disciplines: (i) science; (ii) mathematics; (iii) social studies; and (iv) English/language arts.

Within FIGS. 4A-4J, a plurality of identifiers corresponding to specific educational standards of the State of North Carolina are dispersed throughout the content adjacent to selected items of viewable alphanumeric text, with different identifiers corresponding to specific educational standards as provided in the index 300 represented in FIGS. 3A-3J.

Referring to FIG. 4A, the frame 400A includes the following identifiers correlated to North Carolina educational standards: “S19” at the end of the first full sentence; “SS15” at the end of the second sentence of the second paragraph; and “M12” at the end of the sentence within the dark page-width window near the bottom of the frame 400A.

Referring to FIG. 4B, the frame 400B is devoid of any identifiers correlated to North Carolina educational standards.

Referring to FIG. 4C, the frame 400C includes the following identifiers correlated to North Carolina educational standards: “E19” and “M10” at the end of the final sentence within the upper dark page-width window; and “E11” and “E15” at the end of the final sentence within the lower dark page-width window. As indicated in FIG. 4C, content relating to multiple educational standards—including content relating to different academic disciplines or subjects—may be embodied in the same sentence or the same paragraph (and within the same page) of the instructional aid.

Referring to FIG. 4D, the frame 400D includes the following identifiers correlated to North Carolina educational standards: “E8” at the end of the final sentence within the upper dark page-width window; and “M7” disposed in the middle of the first sentence of content below the upper dark window.

Referring to FIG. 4E, the frame 400E includes the following identifiers correlated to North Carolina educational standards: “M9” at the end of the first sentence and at the end of the second sentence within the upper dark page-width window; “SS15” at the end of the first sentence between the dark page-width windows; “SS5”, “E15,” and “E16” at the end of the last sentence within the lower dark page-width window; “E11,” “SS5,” and “E7” at the ends of successive sentences, respectively, below the lower dark page-width window.

Referring to FIG. 4F, the frame 400F includes the following identifiers correlated to North Carolina educational standards: “S3” and “S5” at the end of the second sentence of the second paragraph; “S4” within the ‘Knowledge Nugget’ window at upper right; “E3” and “E10” at the end of the sentence contained in the dark page-width window; and “S6” within the ‘Knowledge Nugget’ window at lower left.

Referring to FIG. 4G, the frame 400G includes the following identifiers correlated to North Carolina educational standards: “E8” at the end of the Analysis Question; “E8,” “E11,” and “E15” at the end of the Synthesis Question; and “E8” and “E15” at the end of the Evaluation Question.

Referring to FIG. 4H, the frame 400H includes the following identifiers correlated to North Carolina educational standards: “M7” in the upper window adjacent to the clock; and “E31” within the Capitalization Rules section on the chalkboard.

Referring to FIG. 4I, the frame 400I includes the identifier “M4” at the bottom of the chalkboard, adjacent to the phrase “distributive property,” correlated to North Carolina educational standards.

Referring to FIG. 4J, the frame 400J includes the following identifiers correlated to North Carolina educational standards: “E8,” “E11,” and “E15” at the end of the Analysis Question; “S5” and “E15” at the end of the Synthesis Question; and “E8,” “E15,” and “E17” at the end of the Evaluation Question.

As is apparent from the foregoing FIGS. 4A-4J, content contained within instructional aids according to the present invention may include alphanumeric text, illustrations, drawings, diagrams, figures, equations, and content windows of various types to promote organization, to emphasize desired content, and to direct students/readers to topics for discussion or written response activities. Additional content may be embodied in features such as charts, graphs, puzzles, and the like.

In another embodiment, an instructional aid according to the present invention may comprise an electronic medium, including electronic print media. An instructional aid may be embodied at least in part in a computer-readable instruction set such as software that may be saved to a memory element. Such instruction set or software may operate in conjunction with a microprocessor-based computing device having an associated input element and an associated display element arranged to display content and/or at least a portion of an index of identifiers correlated to academic standards for at least one region. Examples of suitable computing devices include desktop computers, laptop computers, multimedia/game consoles, personal digital assistants, portable telephones, electronic presentation boards, and wireless electronic reading devices (e.g., Kindle™, Amazon.com, Seattle, Wash.). Such computing device may include an instruction set or software in memory internal to the device or in a removable memory element, or at least a portion of the instruction set or software may be stored in a memory located remotely from the computing device, with the instruction set or software being accessible via a communication network (e.g., internet, wired telephone network, wireless telephone network, WiFi, or WiMax). A microprocessor-based computer hardware and software system may incorporate an instructional aid according to the present invention. A microprocessor-based hardware device may be used to access, via a network, an instructional aid that is remotely stored on a server or other accessible memory element.

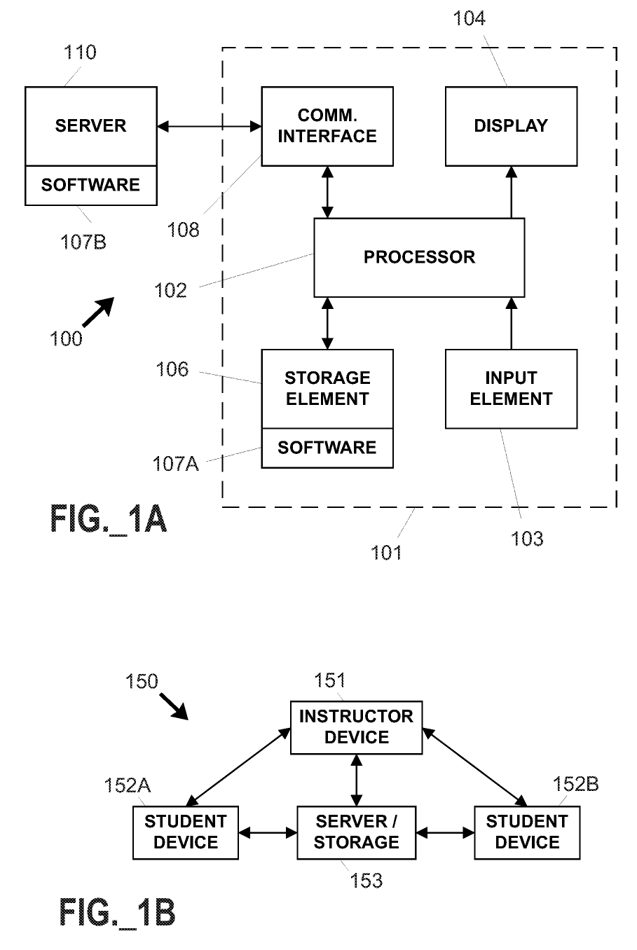

Relative arrangements of computer hardware and software components of an instructional aid and/or a system comprising an instructional aid are shown in FIG. 1A. A system 100 includes an electronic media instructional aid device 101 that preferably includes a processor 102, a user input element 103, a display element 104, and a storage element 106 optionally including software 107A or a computer-readable instruction set embodying content and identifiers as disclosed herein. The instructional aid device 104 preferably includes a communication interface 108 (e.g., for wired and/or wireless communication of any suitable type, whether to a single specified other device or a network that may include other user interfaces). The communication interface 108 may be arranged to communicate with an external host or server 110 (or an external communication device), with the external device 110 optionally being arranged to run software 107B or a machine-readable instruction set embodying content and identifiers, and desirably including an index correlating identifiers to region-specific educational standards, as disclosed herein. Communications between the communication interface 108 and the external host or server 110 may be facilitated by a wired or wireless link, and is preferably implemented via a local or distributed computer or telecommunications network (e.g., an intranet or the Internet, and/or a telephone or other data network).

In one embodiment, multiple electronic media devices 151, 152A, 153B may be arranged to communicate with one another, whether directly or through one or more intermediary server and/or storage elements 153. The resulting communication system 150 may enable dissemination of content (e.g., software, modules, updates, and/or customized lesson plans or additional content added by an instructor) from an electronic instructor device 151 to one or more electronic student devices 152A-152B. An associated server and/or storage element 153 may track usage of student devices 152A, 152B and make such usage information available to the instructor device 151. Student devices 152A-152B may be allowed to communicate with one another, whether directly or through an intermediary device 151 or 153 to regulate timing and flow of content, such as to enable multiple students to discuss content, and/or collaborate or otherwise work together on projects or lessons relating to the content.

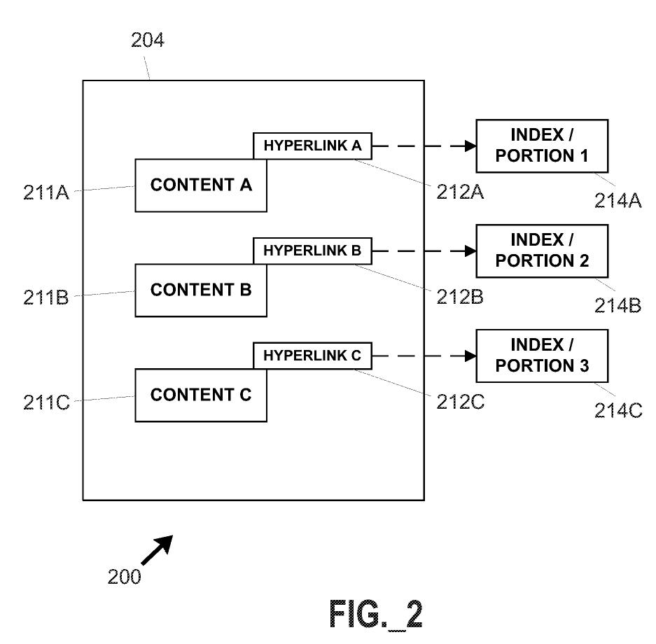

In an instructional aid comprising an electronic medium according to one embodiment of the present invention, identifiers corresponding to region-specific educational standards may be embodied in hyperlinks allowing display of an index of identifiers or a portion thereof. As shown in FIG. 2, a display window 204 of an instructional aid 200 may include various items of content, including content items 211A-211C each having at least one associated identifier (corresponding to a region-specific educational standard) in the form of a hyperlink 212A-212C. User selection of each hyperlink 212A-212C (e.g., with an input device) may enable retrieval and/or display of (i) an index correlating identifiers to educational standards of at least one region, and/or (ii) portions 214A-214C of such an index. Each hyperlink may be adapted to permit viewing of the viewable index and/or to a textual identification of an educational standard corresponding to the identifier.

Instructional aids embodying electronic media may include media in numerous forms, including alphanumeric text, puzzles, cartoons, interactive exercises, games, and so on. User entries may be stored in a memory element arranged local to or remote from an instructional device used by a student, to enable tracking of student usage and responses. In one embodiment, student usage information may be transmitted to a data repository and/or reporting module to enable usage and/or proficiency tracking on the basis (or bases) of specific students, classrooms, schools, school districts, states, and/or other regions.

In another embodiment, an educational instruction method includes providing access to, and/or using, an instructional aid as disclosed herein. The instructional aid may comprise a non-electronic print medium, or an electronic medium.

Embodiments of the present invention therefore overcome difficulties associated with adapting and correlating numerous generic resources to the educational standards applicable to a specific region. An instructional aid may be tailored to one or more sets of specific educational standards, with such instructional aid including multiple identifiers dispersed within the instructional aid adjacent to at least selected items of said viewable alphanumeric text, wherein different identifiers correspond to specific educational standards of the at least one region. The content may consist primarily of fiction, and/or may encompass least two of the following academic disciplines (i) to (iv): (i) science; (ii) mathematics; (iii) social studies; and (iv) any of English, language arts, reading, and writing. A single instructional aid may be used for each grade level to satisfy all region-specific educational standards. Integration of thematic elements in a single work consisting primarily of fiction avoids the need for students to switch frequently between different instructional aids, and may help students retain interest and maintain engagement with content embodied therein.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. An instructional aid correlated to educational standards of at least one region, the instructional aid comprising:
viewable alphanumeric text embodying content to be conveyed to a student; and
a plurality of identifiers dispersed within the instructional aid adjacent to at least selected items of said viewable alphanumeric text, wherein different identifiers of said plurality of identifiers correspond to specific educational standards of the at least one region;
wherein the instructional aid is characterized by at least one of the following features (a) and (b):
(a) the content encompasses a plurality of academic disciplines, including at least two of the following academic disciplines (i) to (iv): (i) science; (ii) mathematics; (iii) social studies; and (iv) any of English, language arts, reading, and writing; and
(b) the content consists primarily of fiction.

2. The instructional aid of claim 1, wherein the content encompasses a plurality of academic disciplines, including at least two of the following academic disciplines (i) to (iv): (i) science; (ii) mathematics; (iii) social studies; and (iv) any of English, language arts, reading, and writing.

3. The instructional aid of claim 1, wherein the content consists primarily of fiction.

4. The instructional aid of claim 1, further comprising a viewable index correlating said plurality of identifiers to educational standards of the at least one region.

5. The instructional aid of claim 1, wherein the instructional aid comprises a non-electronic print medium.

6. The instructional aid of claim 1, wherein the instructional aid comprises at least one of a book, a pamphlet, and a transparency adapted to permit projected display.

7. The instructional aid of claim 1, wherein the instructional aid comprises an electronic medium.

8. The instructional aid of claim 1, wherein the instructional aid comprises software adapted to operate on a microprocessor-based computing device having an associated input element and an associated display element arranged to display at least one of said alphanumeric text and said viewable index.

9. The instructional aid of claim 8, wherein the instructional aid is accessible via a computer network.

10. A microprocessor-based computer hardware and software system incorporating the instructional aid of claim 8.

11. The instructional aid of claim 7, wherein each identifier of the plurality of identifiers comprises a selectable hyperlink, wherein the hyperlink is adapted to permit viewing of at least a portion of the viewable index and/or to a textual identification of an educational standard corresponding to the identifier.

12. The instructional aid of claim 3, wherein the content is integrated with a fictional storyline.

13. The instructional aid of claim 1, wherein the educational standards of at least one region includes educational standards of a plurality of regions.

14. The instructional aid of claim 1, wherein at least some identifiers of the plurality of identifiers are paragraph-specific and/or sentence-specific.

15. The instructional aid of claim 1, wherein at least some identifiers of the plurality of identifiers are specific to one or more drawings, diagrams, figures, or equations included in said content.

16. An educational instruction method including providing access to, and/or using, the instructional aid of claim 1.

17. The educational instruction method of claim 16, wherein the instructional aid comprises a non-electronic print medium.

18. The educational instructional method of claim 16, wherein the instructional aid comprises an electronic medium.

19. The educational instructional method of claim 18, wherein each identifier of the plurality of identifiers comprises a selectable hyperlink, wherein the hyperlink is adapted to permit viewing of the viewable index and/or to a textual identification of an educational standard corresponding to the identifier.

20. The educational instructional method of claim 16, wherein the content encompasses a plurality of academic disciplines, including at least two of the following academic disciplines (i) to (iv): (i) science; (ii) mathematics; (iii) social studies; and (iv) any of English, language arts, reading, and writing.
